(19) United States
(12) Patent Application Publication
(10) Pub. No.: US 2008/0152584 A1
(43) Pub. Date: Jun. 26, 2008

(54) Method and Composition for Production of Hydrogen

(76) Inventor: Jasbir Kaur Anand, Seattle, WA (US)

Correspondence Address: TODD N. HATHAWAY, 119 N. COMMERCIAL ST. #620, BELLINGHAM, WA, 98225, US

(21) Appl. No.: 11/794,526

(22) PCT Filed: Jan. 3, 2006
(86) PCT No.: PCT/US06/00180

§ 371 Date: Aug. 23, 2007

Related U.S. Application Data
(60) Provisional application No. 60/640,524, filed on Dec. 31, 2004.

(51) Int. Cl. C01B 3/08

(52) U.S. Cl. 423/657

(57) ABSTRACT

A method and composition for producing hydrogen by water split reaction, at near neutral pH conditions and without requiring preheating of the reactant materials. Metallic aluminum in particulate form is combined with a metal oxide initiator that raises the temperature of the reactant material upon exposure to water, to a level which initiates reaction of water with the aluminum to generate hydrogen, and a catalyst that creates progressive pitting of the metallic aluminum to prevent passivation. The metal oxide initiator may be an alkaline metal earth oxide, with calcium oxide being preferred. The catalyst may be a water soluble inorganic salt having an aggressive anion, such as the halides, sulfites, sulfates and nitrates of alkaline metals and alkaline earth metals, with sodium chloride being preferred. The metallic aluminum may be in the form of a milled particulate, and may be combined with the salt catalyst in a mechanical alloy. The reaction initiates upon adding normal tap water at ambient temperature, and is capable of generating hydrogen at low pressures or at elevated pressures of 7,000 psig or more. The reaction products can be recycled or disposed of safely without presenting hazards to the environment.

### RELATED APPLICATIONS

This application claims the benefit of U.S. Provisional Patent Application No. 60/640,524 filed on 31 Dec. 2004.

### BACKGROUND

a. Field of the Invention

The present invention relates generally to the production of hydrogen, and, more particularly, to methods and compositions for producing hydrogen from water at near neutral pH and at near ambient temperatures and pressures.

b. Related Art

Hydrogen holds great potential as a “clean” fuel, whether for use in combustion engines, in fuel cells, or other devices. However, as is well known, a number of drawbacks inherent in current methods for production and supply of hydrogen have heretofore stymied the widespread use of hydrogen as a fuel.

The most common methods of producing hydrogen have been extraction from fossil fuels, such as natural gas or methanol, and electrolysis (i.e., passing electric current through water to disassociate the molecules). Both methods suffer from serious inefficiencies, and furthermore, hydrocarbons represent a nonrenewable and increasingly expensive resource. Moreover, these processes commonly require a comparatively large, stationary plant, so that subsequent storage and transportation of the hydrogen to the end user (e.g., in compressed tanks) is expensive, complex and potentially dangerous. In some instances, particularly in the case of vehicles, hydrogen has been extracted from a liquid hydrocarbon fuel (e.g., gasoline and/or methanol) that is carried in a non-pressurized tank; while perhaps less dangerous than transporting hydrogen under pressure, such systems have remained costly and complex, and moreover produce environmentally undesirable emissions in the form of carbon dioxide, monoxide and other gasses.

Hydrogen may also be generated on a stationary or portable basis, by chemical reaction. As is well known, hydrogen can be produced by reaction between water and certain metal hydrides, including lithium hydride (LiH), lithium tetrahydridoaluminate (LiAlH₄), lithium tetrahydridoborate (LiBH₄), sodium hydride (NaH), sodium tetrahydridoaluminate (NaAlH₄) and sodium tetrahydridoborate (NaBH₄). However, the reactions are highly exothermic and potentially dangerous, so that the rate at which water is combined with the chemical hydride must be precisely controlled in order to avoid a runaway reaction and potential explosion. Achieving such control has proven elusive: Most efforts have focused on the use of catalysts, however, it has been found that when the reactions are controlled at levels that avoid runaway exothermic conditions they become unacceptably inefficient, due in part of accumulation of reaction products on the catalysts. Other attempts at controlling water-chemical hydride reactions have taken the approach of physically separating the reactants (e.g., using membranes), but have generally proven impractical.

Hydrogen can also be produced by the simple reaction of water with alkaline metals, such as potassium or sodium. However, these reactions are not just exothermic but in fact violent, making them even more difficult to control than the water-metal hydride reactions described above. Moreover, the residual hydroxide product (e.g., KOH) is highly alkaline, corrosive and dangerous to handle, as well as being hazardous to the environment. However, attempts to use metals having more benign characteristics (e.g., aluminum) have largely been stymied by the tendency of reaction products to deposit on the surface of the metal, blocking further access to the surface and bringing the reaction to a halt in a phenomenon known as “passivation”.

Accordingly, there exists a need for a method and composition for generation of hydrogen from water as a renewable resource, which are efficient in terms of both energy utilized and reactants consumed. Moreover, there exists a need for such a method and composition in which the reaction takes place in a readily controlled manner, and at or near ambient temperatures and pH levels, for the sake of efficiency and safety. Still further, there exists a need for such a method and composition that does not require compressed hydrogen or other potentially dangerous materials to be transported to the end user. Still further, there exists a need for such a method and composition that are benign in terms of their impact on the environment and that do not produce undesirable waste or byproducts.

### SUMMARY OF THE INVENTION

The present invention has solved the problems cited above, and provides a method for producing hydrogen using a safe and environmentally benign reaction that does not require preheating of the materials employed. Broadly, the method comprises the steps of: (a) providing a reactant material comprising: metallic aluminum for reacting with water to generate hydrogen, a catalyst effective to create progressive pitting of the metallic aluminum when reacting with water, and an initiator effective to raise the temperature of the reactant material upon exposure to water, and (b) selectively combining the reactant material with water, so that the initiator raises the temperature to a level which initiates reaction of water with the aluminum to generate hydrogen, and the catalyst prevents passivation of the aluminum so as to enable the reaction to continue on a sustained basis.

The catalyst may comprise a water soluble inorganic salt. The inorganic salt may be selected from the group consisting of halides, sulfites, sulfates and nitrates of Group 1 and Group 2 metals and combinations thereof. The inorganic salt may be selected from a group consisting of sodium chloride, potassium chloride, potassium nitrate and combinations thereof. In a preferred embodiment, the inorganic salt is sodium chloride, in a ratio to the metallic aluminum of about 1:1 by weight.

The initiator may comprise a metal oxide. The metal oxide may be selected from the group consisting of oxides of Group 2 metals and combinations thereof. The metal oxide may be selected from the group consisting of calcium oxide, magnesium oxide, barium oxide and combinations thereof. In a preferred embodiment, the metal oxide is calcium oxide, in an amount from about 0.5% to about 4% of said reactant material by weight.

The metallic aluminum, catalyst and initiator may be combined in particulate form to form the reactant material. The metallic aluminum and catalyst may be mechanically alloyed in the material.

The step of combining the reactant material with water may comprise combining the reactant material with water at ambient temperature, and at neutral pH. The method may further comprise the step of generating the hydrogen under an elevated pressure in the range from about 600 psig to about 8,000 psig.

The invention further provides a fuel material for being selectively reacted with water to produce hydrogen. Broadly, the fuel material comprises: metallic aluminum, an initiator effective to raise the temperature of the material upon exposure to water, to a level which initiates reaction of water with said aluminum to generate hydrogen, and a catalyst effective to create progressive pitting of the metallic aluminum when reacting with water, so as to prevent passivation of the aluminum and thereby enable the reaction to continue on a sustained basis.

The initiator may comprise a metal oxide, and may be a metal oxide selected from the group consisting of metal oxides of Group 2 metals and combinations thereof. The metal oxide may be selected from the group consisting of calcium oxide, magnesium oxide, barium oxide and combinations thereof. In a preferred embodiment, the metal oxide is calcium oxide, in an amount from about 2% to about 4% of the reactant material by weight.

The catalyst may comprise a water soluble inorganic salt, and may be selected from the group consisting of halides, sulfites, sulfates and nitrates of Group 1 and Group 2 metals, and combinations thereof. The inorganic salt may be selected from the group consisting of sodium chloride, potassium chloride, potassium nitrate and combinations thereof. In a preferred embodiment, the inorganic salt is sodium chloride, in a ratio to the metallic aluminum of about 1:1 by weight.

The metallic aluminum, catalyst and initiator may be combined in particulate form to form the reactant material, and may be mechanically alloyed in the material.

These and other features and advantages of the present invention will be more fully appreciated from a reading of the following detailed description with reference to the accompanying drawings.

### BRIEF DESCRIPTION OF THE DRAWINGS

FIG. 1 is a line graph of hydrogen production versus time for reactions carried out at ambient temperature in accordance with the present invention, showing the manner in which hydrogen production varies with the amount of metal oxide initiator in the reactant material;

FIG. 2 is a bar graph of the data presented in FIG. 1, showing the relative hydrogen yields for the different percentages of metal oxide initiator in the reactant material;

FIG. 3 is a line graph of hydrogen production versus time, showing hydrogen production for the same reactants and percentages of metal oxide initiator as in FIG. 1, but with the reaction being carried out at an elevated temperature of 55° C.;

FIG. 4 is a bar graph of the data of FIG. 3, showing in a manner similar to FIG. 2 the relative hydrogen production for the differing percentages of metal oxide initiator;

FIG. 5 is a bar graph of pressure versus percentage yield of hydrogen, for reactions carried out in accordance with the present invention at elevated pressures between 300 psig and 7,000 psig;

FIG. 6 is a bar graph of percentage yield of hydrogen versus percentage of metal oxide initiator in the reactant material, showing the yields for the differing amounts of metal oxide initiator when the reaction is conducted at an elevated pressure;

FIG. 7 is a bar graph of percentage hydrogen yield versus percent of metal oxide initiator in the reactant material, showing the percentage yields for the differing percentages of metal oxide initiator when the reactions are conducted at a relatively low pressure of about 100 psig;

FIG. 8 is a bar graph of pressure versus percentage yield of hydrogen for the differing amounts of metal oxide initiator shown in FIG. 7; and

FIG. 9 is a bar graph of percentage yield of hydrogen versus time for relatively large-scale, continuous reactions conducted using varying percentages of metal oxide initiator.

### DETAILED DESCRIPTION

a. Overview

The present invention reacts a mixture of metallic aluminum and a metal oxide initiator with water, in conjunction with a water soluble salt catalyst, to generate hydrogen at ambient temperatures and pressures, and at neutral or near neutral pH levels. The reactants are therefore able to achieve a rapid and efficient water split reaction using (for example) ordinary tap water, without requiring preheating. Furthermore, complex regulation of the reactants is not needed. The reaction is also highly productive when conducted at elevated temperatures and pressures.

The metallic aluminum, initiator and catalyst are preferably in particulate form (e.g., pulverized) and are mixed to achieve a substantially uniform distribution. The initiator is suitably an alkaline earth metal oxide, such as calcium oxide (CaO). The catalyst is suitably an alkali salt, such as sodium chloride (NaCl) or potassium chloride (KCl). The particle size is preferably in the range from about 0.01 mu.m. to about 1,000 mu.m.

The mixture is stable, in the absence of water, and is easily transported without being hazardous. The proportions of the constituents can vary, in part as a function of the form and consistencies in which the mixture is utilized. In some embodiments, the pulverized constituents can be combined with water simply as a pulverized, unconsolidated powder; this mixture is reactive at ambient temperatures and in general has been observed to be little effected by elevated temperature. A coarser powder, by contrast has been found to be more temperature sensitive. The material may also be formed into pellets.

The reaction can initiate at ambient temperatures. The starting pH is suitably in the range of about 4-8, preferably in the range of about 5-7, and remains substantially neutral (i.e., in the range of about 4-10) for the duration of the reaction. The reaction proceeds for the mass ratio of aluminum to calcium oxide or alkali salts, varying over the range of a few percent up to 99 percent of the catalyst/additives. Because the aluminum metal oxide initiator and catalyst are blended into intimate physical contact, the catalyst particles expose fresh surfaces as the reaction proceeds, thus preventing “passivation” and enabling the reaction to proceed to a high degree of completion, i.e., until the aluminum is substantially consumed. Regardless of whether the reaction takes place at ambient or elevated temperatures, substantially the same amount of hydrogen is produced.

The principle products of the reaction are hydrogen (H₂), aluminum hydroxide (Al(OH)₃/AlOOH), calcium hydroxide (Ca(OH)₂), and calcium oxide (CaO), all of which are substantially benign in character. Aluminum can be regenerated from the aluminum hydroxide, i.e., the reaction product is recyclable.

The present invention thus renders it feasible to generate hydrogen by reacting aluminum with water, under far safer and more controllable conditions than with the chemical hydride and alkaline metal reactions described above. As an additional advantage, the aluminum smelters that produce the metallic component typically employ hydroelectric power, so that production of the primary material used in the reaction employs a renewable energy resource that creates essentially no emissions.

b. Reaction Process and Material

As is well known, metallic aluminum reacts with water to generate hydrogen, but also forms Al(OH)₃ or AlOOH, and Al₂O₃. These three chemicals tend to deposit on the metal surface and restrict further reaction of water with the metal; this tendency, referred to as “passivation”, is an important property of Al metal, and preserves the metal from further corrosion under neutral conditions. Passivation of aluminum consequently plays a significant role inhibiting the hydrogen generation from water and aluminum under near-neutral pH conditions.

The present invention prevents the development of passivation, by exposing the aluminum to water-soluble inorganic salts, particularly halide salts, that act as catalysts to create a sequential pitting process. Pitting corrosion is initiated by aggressive anions like chlorides, nitrates, and sulfates or alkali or alkaline earth metals. The pits are formed by halide/chloride ion adsorption at the metal oxide surface, followed by penetration of the oxide film, corrosion pit propagation, and rupture of corrosion cells due to enclosed hydrogen formation.

The catalysts are consequently selected from water-soluble inorganic salts, primarily the halides, sulfides, sulfates and nitrates of Group 1 or Group 2 metals and their mixtures. The preferred water-soluble catalysts include NaCl, KCl, and NaNO3, in pure or combined form; NaCl is general most preferred, owing to its high solubility, efficacy and low cost, as well as its benign health and environmental characteristics; KCl is also inexpensive and effective, however, it is a suspected mutagenic compound and therefore less desirable from a safety standpoint. Other catalysts that may be employed include alumina, ESP (a waste product available from Alcoa Inc., USA), aluminum hydroxide and aluminum oxide, generally in combination with one or more of the preferred salts identified above. Using NaCl, the metal-to-salt ratio is preferably about 1:1 by weight ratio, although ratios in the range from about 9:1 to 1:9 may be employed in some instances.

The initiator is suitably an alkaline earth metal oxide; other metal oxides may be employed, but many yield reaction products that interfere with the aluminum-water split reaction, or that are undesirable from a safety or environmental standpoint. CaO, MgO and BaO are preferred, with CaO being most preferred, due again to its efficacy and the benign nature of the material and its reaction products. As will be described below, the initiator raises the temperature of the material when exposed to water; the increase is sufficient to raise the temperature to a level at which the water-aluminum reaction initiates, thus obviating the need for preheating, but is modest and safe by comparison with the other exothermic reactions described above.

The initiator enables the water split reaction to commence rapidly at room temperature. For example, as will be described below, the water split reaction of an aluminum-salt system without an initiator took in excess of 120 minutes to complete at 55° C., whereas the same reaction using an initiator completed at room temperature (20° C.) within 20 minutes. Thus in addition to eliminating the need to supply external heat energy, the initiator both accelerates the rate of reaction and reduces the reaction time.

In a preferred embodiment, the aluminum and water soluble inorganic salt are mechanically alloyed or blended, thus enabling the water soluble salt to perform most effectively as a catalyst to support the water split reaction. Blending the metal and catalyst in the form of very fine particles, from about 10 to 1000 um, produces the highest yields and rates of production; suitable, very fine particle size can be achieved by various milling techniques including, for example, Spex milling, rotor milling, attrition milling and ball milling. Pre-milling of the catalysts further reduces the particle size and can therefore enhance its effectiveness.

During the milling process the metal is deformed plastically, so that the constituents become mechanically alloyed. The catalyst is preferably pre-milled to reduce its particle size, and the aluminum powder is blended in and the milling continued to plastically deform the metal. Mechanically alloying the salt and the metallic aluminum ensures intimate contact between the two as the metal is eroded during the reaction process, causing continuous exposure of fresh Al surfaces for reaction with the water; in general, the metal oxide initiator is included as a separate particulate tat is mixed with the alloyed aluminum-salt particulate, to ensure more immediate and rapid contact with the water; however, in some embodiments it too may be mechanically alloyed with the aluminum and salt. In some embodiments, moreover, the pulverized metal may be first formed into pellets or wafers and then mixed with powdered metal oxide initiator and salt catalyst.

The following sections describe example reactions in accordance with the method of the present invention that are directed to particular targets and/or applications.

c. Water Bath Reactions

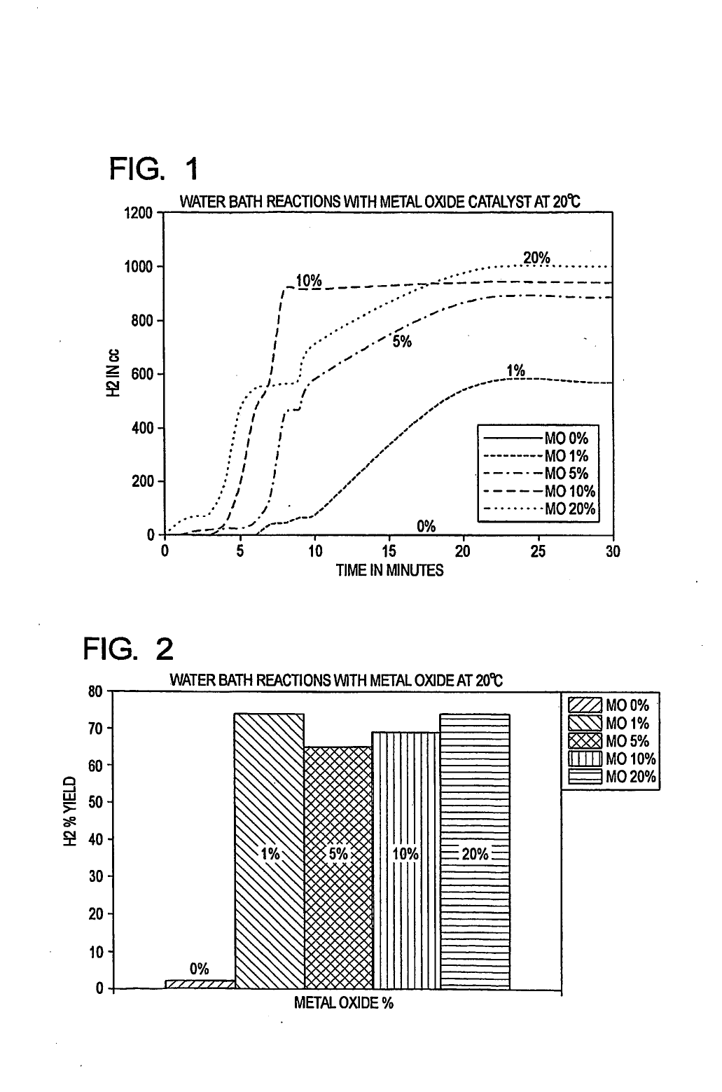

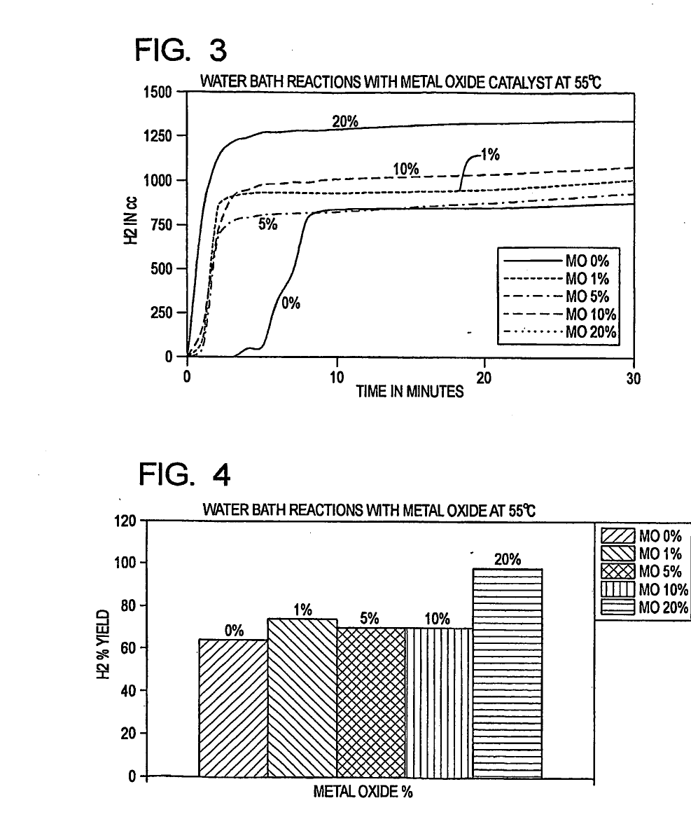

FIGS. 1-4 illustrate the results of water bath reactions using the metallic aluminum and salt catalyst in combination with varying proportions of metal oxide initiator, ranging from 0% to 20% by weight (0%, 1%, 5%, 10%, 20%). A first series of reactions was conducted at a room temperature of 20 C (FIGS. 1-2), and a second series was conducted at an elevated temperature of 55 C (FIGS. 3-4). For each of the examples, Al powder (99% Al, 40 um particle size 5 gm) and sodium chloride (common salt, 400 um particle size, 5 g) were milled for 15 minutes. 2 g of the milled powder composite of the present invention was placed in a paper filter bag, together with the amount of metal oxide initiator specified in the graphs (i.e., 0%, 1%, 5%, 10%, 20%). The bags were then immersed in tap water at ph=6 and; the first series of reactions was carried out at room temperature (T=20 C), while the second was carried out at an elevated temperature (55 C) requiring application of external heat. The total amount of hydrogen released in 30 minutes was measured, and data was compared from all the reactions.

It will be observed from FIGS. 1-4 that the reactions behaved differently depending on the different amounts of metal oxide, at both room and elevated temperatures.

As can be seen in FIG. 1, compositions that included any metal oxide initiator commenced significant hydrogen production within between about 3 minutes and 10 minutes at room temperature (20 C; the rations have proceeded rapidly to completion, requiring about 7-20 minutes depending on the amount of initiator. By contrast, compositions containing no initiator did not generate any appreciable amount of hydrogen over this period (the curve NO=0% overlies the bottom axis in FIG. 1), and in fact did not do so for a period in excess of 20 hours. At the elevated temperature (see FIG. 3), the 0% metal oxide composition did produce hydrogen, but only after delay of about 5-7 minutes, whereas the compositions that included the metal oxide initiator commenced H₂ production almost instantaneously.

Hence, the water bath reactions demonstrate that the metal oxide initiator not only renders it possible to initiate the aluminum-water split reaction at ambient temperatures, but it also serves to eliminate any “lag” for reactions at elevated temperatures and therefore makes it possible to meet an instantaneous demand for H₂ by a user device.

As can be seen with further reference to FIG. 1, the speed of H₂ generation increases dramatically with an increase in metal oxide content from 1% to 5%. However, from 5% to 10%, and from 10 to 20%, the increase is much less significant, particularly as compared with the proportional decrease in the amount of aluminum-salt in the reactant material and therefore the total amount of hydrogen that can be produced. FIG. 2, in turn, shows that the percentage yield of hydrogen does not differ significantly with the amount of metal oxide initiator (above the minimum of about 0.6-1%). Similarly, FIG. 4 shows that the percentage yield of hydrogen differs little with changes in the amount of metal oxide initiator over a range from 1-10%, when the reaction is conducted at elevated temperature; the use of 20% metal oxide shows a somewhat higher percentage yield, but again this is at the expense of the aluminum-salt proportion and therefore the total yield of hydrogen.

Hence, based on testing, and taking into account the relative proportions of the metal oxide and aluminum-salt components, it has been determined that an initiator content of about 2-4% is optimal for a majority of applications.

In summary, FIGS. 1-4 demonstrate that for the same amount of Al in the alloy mix, the metal oxide initiator enhanced the reaction yields by 25%-35%, accelerated the reaction kinetics, reduced the reaction start-up time and augmented the percentage yield of hydrogen.

d. High-Pressure Reactions—600+psig

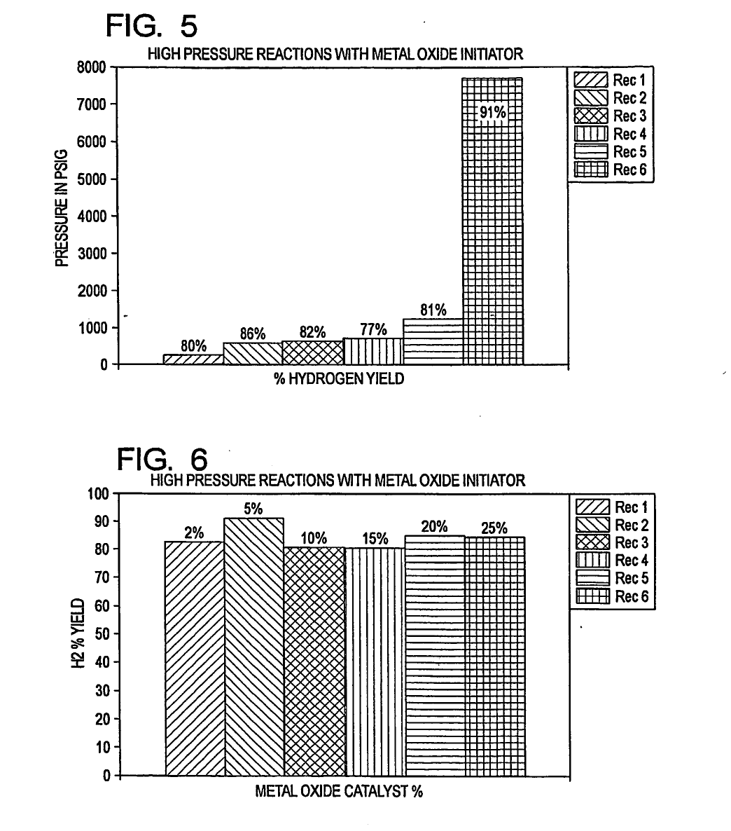

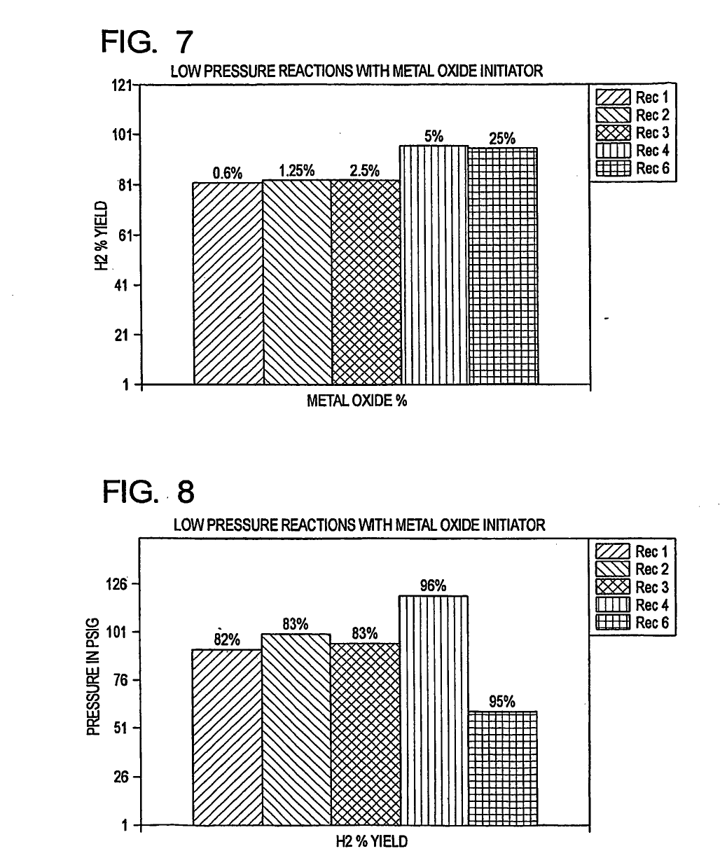

Certain user and storage applications call for hydrogen to be supplied at elevated pressures. FIGS. 5-6 demonstrate reactions that were conducted for varying amount of metal oxide initiator, within pressures ranging from about 300 psig to 7000+psig.

For the high-pressure reactions, 8 g of the reactant material (with the specified amount of initiator) was poured into a paper filter bag and the filter bag was placed at the bottom of a steel tube reactor. Finally, 32 g of water was added to reactor, the reactor tube was sealed, and the amount of hydrogen generated within 30 minutes was quantified. The reactions were carried mainly in the pressure range of 600 psig to 8000 psig, and all utilized metal oxide initiators; in the absence of an initiator no appreciable amount of hydrogen was released in 30 minutes. The metal oxide initiator was used in proportions of 2% to 25%, and all reactions were completed within 5 minutes.

As can be seen in FIG. 5, all of the reactions completed successfully at the elevated pressures, and all generated hydrogen yields well in excess of 70%, with slightly above 80% being the average. Moreover, as is shown in FIG. 6, the percentage yields varied little with the differing amounts of metal oxide initiator (2%, 5%, 10%, 15%, 20%, 25%), again indicating that an amount above about 5% is generally unnecessary and about 2-4% is generally optimal. Furthermore, the reactions using the metal oxide initiator resulted in hydrogen yields about 20% higher than the 50-70% yields obtained in reactions (conducted at elevated temperatures) without the initiator.

In summary, the data presented by FIGS. 5-6 demonstrates that the method and compositions of the present invention are capable of effectively generating hydrogen at elevated pressures, obviating the need for a separate compression step and machinery where high-pressure hydrogen is needed.

e. Low Pressure Reactions—20 to 350 psig

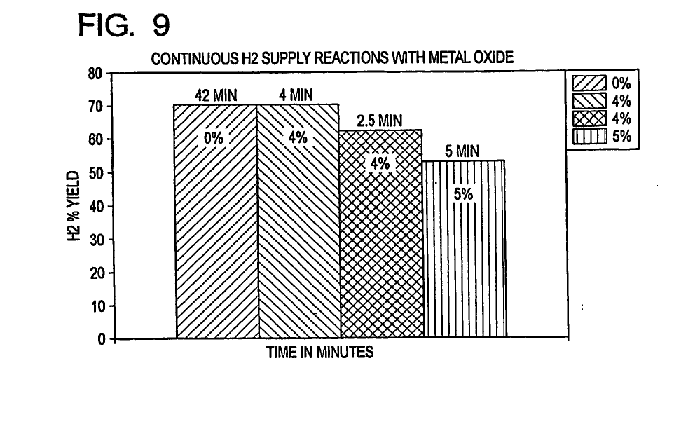

FIGS. 7-8 demonstrates the ability of the reaction to effectively generate hydrogen at relatively low pressures as well.

In these examples, 10 g of reactant material (with/without initiator) was placed in a paper filter bag, and the paper bag was encapsulated in a metallic mesh to form a cartridge. This reaction cartridge was dropped in a steel cylindrical vessel lined with an insulator and containing 30 g of water. The reactor vessel was then sealed, and the hydrogen released within 30 minutes was collected and quantified.

The reaction pressures were varied from about 50 psig to 350 psig, with the results in the graphs generally being obtained below 125 psig. The amount of metal oxide initiator used in the reactions was varied from 0.6% to 25%.

The reactions using the metal oxide initiator again started instantaneously. Furthermore, reaction yields were not affected significantly by the varying proportional amounts of metal oxide initiator, with all reactions achieving yields in excess of 80% (82-96%).

The results set forth in FIGS. 7-8 demonstrate the ability of the reaction to generate hydrogen effectively at relatively low pressures, which are desirable or suitable for certain applications and user devices. Moreover, the results demonstrate the controllability of the reaction process, i.e., the ability for the reaction to generate hydrogen at moderate pressures without developing a runaway or out-of-control condition.

f. Large-scale, Rapid Start Reactions

The goal of this set of reactions is to fabricate hydrogen generators suitable to run automobiles and other user devices having similar demand characteristics. These are large-scale reactions generating 10 g to 100 g of hydrogen. In these examples, 100 g of reactant material (with/without initiator) was placed in a filter bag. The sealed bag was placed in a 2 liter steel reactor. Water 300 g was then introduced into the reactor by a peristaltic pump and the reactor sealed. Hydrogen generated within a 30-minute period was quantified by pressure/volume measurements and Ideal Gas law relationships.

Once again, as can be seen in FIG. 9, it was observed that the use of the metal oxide is critical, and in fact essential from a practical standpoint: without the initiator, the reaction required over 40 minutes to release an adequate amount of hydrogen, which is unacceptable for automobiles and similar applications. Use of 4-5% metal oxide initiator, however, reduced this time to an acceptable 2.5-5 minutes, during which time the automobile or other user device may be temporarily supplied from a pre-charged buffer or other reservoir or storage device.

g. Conclusions/Observations

The reaction can be customized to generate the desired amount of hydrogen at a linear, controlled rate at a set pressure or pressures. The reactions can be modified to generate hydrogen at very low pressures, around 10 psig, or at pressures as high as 8000 psig, depending upon the needs of the application.

The proportion of metal oxide initiator may vary from 0.1% to 35% by weight, with 2-4% generally being preferred. As compared with compositions that lack an initiator, reaction yields can be increased by 10% to 60%, with a significant energy saving since no external heat energy is required to start hydrogen generation.

The water split reaction with initiator is slightly more exothermic than the reaction without initiator, and generates temperatures around 50°+C. At such temperatures, the prominent reaction product of Al and water is AlOOH, rather than Al(OH)3 produced at <50° C. temperatures. Formation of AlOOH requires significantly less amount of water (one third) than formation of Al(OH)₃, consequently the initiator also offers a significant weight advantage and enables systems using the present invention to achieve higher energy densities.

The reaction products from the water split reaction can be recycled or, if desired, the spent fuel can be flushed down the drain without fear of environmental damage.

It is to be recognized that various alterations, modifications, and/or additions may be introduced into the constructions and arrangements of parts described above without departing from the spirit or ambit of the present invention as defined by the appended claims.

What is claimed is:

1. A method for producing hydrogen, said method comprising the steps of:
providing a reactant material, comprising:
metallic aluminum for reacting with water to generate hydrogen;
a catalyst effective to create progressive pitting of said metallic aluminum when reacting with water; and
an initiator effective to raise the temperature of said reactant material upon exposure to water; and
selectively combining said reactant material with water, so that said initiator raises the temperature to a level which initiates reaction of water with said metallic aluminum to generate hydrogen and said catalyst prevents passivation of said aluminum so as to enable said reaction to continue on a sustained basis.

2. The method of claim 1, wherein said catalyst comprises:
a water-soluble inorganic salt.

3. The method of claim 2, wherein said water-soluble inorganic salt is selected from the group consisting of:
halides, sulfides, sulfates and nitrates of Group 1 and Group 2 metals, and combinations thereof.

4. The method of claim 3, wherein said inorganic salt is selected from the group consisting of:
sodium chloride;
potassium chloride;
potassium nitrate; and
combinations thereof.

5. The method of claim 4, wherein said inorganic salt is sodium chloride, in a ratio to said metallic aluminum of about 1:1 by weight.

6. The method of claim 1, wherein said initiator comprises:
a metal oxide.

7. The method of claim 6, wherein said metal oxide is selected from the group consisting of:
oxides of Group 2 metals, and combinations thereof.

8. The method of claim 7, wherein said metal oxide is selected from the group consisting of:
calcium oxide;
magnesium oxide;
barium oxide; and
combinations thereof.

9. The method of claim 8, wherein said metal oxide is calcium oxide, in an amount from about 0.1% to about 4% of said reactant material by weight.

10. The method of claim 1, wherein said metallic aluminum, catalyst and initiator are combined in particulate form to form said reactant material.

11. The method of claim 10, wherein said metallic aluminum and catalyst are mechanically alloyed in said reactant material.

12. The method of claim 1, wherein the step of combining said reactant material with water comprises:
combining said reactant material with water at ambient temperature.

13. The method of claim 1, wherein the step of combining said reactant material with water comprises:
combining said reactant material with water at near neutral pH.

14. The method of claim 1, further comprising the step of:
generating said hydrogen under an elevated pressure in the range from about 600 psig to about 8,000 psig.

15. A method for producing hydrogen, said method comprising the steps of:
providing a mechanically alloyed reactant material, comprising:
metallic aluminum;
sodium chloride in a ratio to said aluminum of about 1:1 by weight; and
calcium oxide in an amount equal to about 0.1% to about 4% of said reactant material by weight; and
selectively combining said reactant material so that said calcium oxide initiates reaction of water with said metallic aluminum to generate hydrogen and said sodium chloride prevents passivation of said aluminum so as to enable said reaction to continue on a sustained basis.

16. A fuel material for being selectively reacted with waiter to produce hydrogen, said material comprising:
metallic aluminum;
an initiator effective to raise the temperature of said material upon exposure to water, to a level which initiates reaction of water with said aluminum to generate hydrogen; and
a catalyst effective to create progressive pitting of said metallic aluminum when reacting with water, so as to prevent passivation of said aluminum and thereby enable said reaction to continue on a sustained basis.

17. The fuel material of claim 16, wherein said initiator comprises:
a metal oxide.

18. The fuel material of claim 17, wherein said metal oxide is selected from the group consisting of:
oxides of Group 2 metals, and combinations thereof.

19. The fuel material of claim 18, wherein said metal oxide is selected from the group consisting of:
calcium oxide;
magnesium oxide;
barium oxide; and
combinations thereof.

20. The fuel material of claim 19, wherein said metal oxide is calcium oxide, in an amount from about 0.1% to about 4% of said reactant material by weight.

21. The fuel material of claim 16, wherein said catalyst comprises:
a water-soluble inorganic salt.

22. The fuel material of claim 21, wherein said water-soluble inorganic salt is selected from the group consisting of:
halides, sulfides, sulfates and nitrates of Group 1 and Group 2 metals, and combinations thereof.

23. The fuel material of claim 22, wherein said inorganic salt is selected from the group consisting of:
sodium chloride;
potassium chloride,
potassium nitrate; and
combinations thereof.

24. The fuel material of claim 23, wherein said inorganic salt is sodium chloride, in a ratio of about 1:1 to said metallic aluminum by weight.

25. The fuel material of claim 16, wherein said metallic aluminum, catalyst and initiator are combined in particulate form to form said reactant material.

26. The fuel material of claim 25, wherein said metallic aluminum and catalyst are mechanically alloyed in said reactant material.

27. A fuel material for being selectively reacted with water to produce hydrogen, said material comprising:
metallic aluminum;
sodium chloride mechanically alloyed with said metallic aluminum in a ratio to said aluminum of about 1:1 by weight; and
calcium oxide in an amount equal to about 0.1% to about 4% of said reactant material by weight.
